(19) United States
(12) Patent Application Publication
(10) Pub. No.: US 2006/0227899 A1
(43) Pub. Date: Oct. 12, 2006

(54) Apparatus and method for storing/recovering spectrum

(76) Inventor: Jae Ha Yim, Seoul (KR)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(21) Appl. No.: 11/101,712

(22) Filed: Apr. 8, 2005

(51) Int. Cl. H04L 27/00

(52) U.S. Cl. 375/316

(57) ABSTRACT

An apparatus and a method for storing/recovering spectrum are provided. The apparatus includes an RF receiver block, a plurality of memory blocks, an RF transmission block, a control circuit. The RF receiver block receives spectrum of signals transmitted through a predetermined RF band (predetermined RF band signals) to down-covert the received spectrum to a predetermined band lower than the predetermined RF band and converts the down-converted spectrum into digital data. The memory blocks stores the converted digital data. The RF transmission block receives the stored digital data to recover the predetermined RF band signals initially received. The control circuit converts information within the spectrum of the down-converted to the predetermined band lower than the predetermined RF band into a data frame using the digital data received from the RF receiver block and stores the data frame in the memory blocks, and controls the RF transmission block to recover the initially received predetermined RF band signals by using the stored data in memory blocks.

### BACKGROUND OF THE INVENTION

1. Field of the Invention

The present invention relates to an apparatus and a method for storing/recovering predetermined RF (radio frequency) spectrum itself transmitted through a predetermined band, and more particularly, to an apparatus and a method for storing/recovering spectrum capable of storing spectrums themselves of wireless (or wired) frequency band that correspond to a predetermined time interval in form of data during operation of wireless (or wired) communication system and reproducing the predetermined RF spectrums themselves of the wireless (or wired) communication system with predetermined bandwidth using stored data.

2. Description of the Related Art

In general communication systems, wireless (or wired) transmitter up-converts the source information (ex: sound and images in baseband) into a predetermined RF (radio frequency) bandwidth using a transmitter circuit and transmit the up-converted information via media like air.

A receiver which is tuned with the predetermined RF bandwidth will down-convert the up-converted transmitted information and recover the source information using the receiver circuit.

The up-converted information generally should be transmitted via transmission media like air or a copper wire. Then, up-converted transmitted signals will be influenced by media characteristics (ex: air, copper wire, etc) during the transmission. Especially, air has time-variant characteristics and air characteristics is also varied depending on geographical environments. So, signals received to an antenna of the receiver are different from originally transmitted signals because of such media's characteristics. Received signals consist of noise and interference signals and originally transmitted signals. These noise and interference signals might come from media characteristics.

If the receiver circuit processes the above distorted-received signals, it will result in distorted source information which are different from original source information. To overcome this problem, a transmitter should include various kinds of baseband signal processing techniques (ex: the baseband signal processing technique for error correcting code, spread spectrum technique, interleaving, etc). Main purpose of these techniques lies in minimization of errors that might be introduced to original source information during the transmission. Generally it is not avoidable to get the distorted source information after receiving process.

Let us define post-baseband signals (or information) as signals (or information) that already be processed by several kinds of baseband signal processing techniques for error correcting code, spread spectrum technique, interleaving, etc.

If we can not avoid errors during the transmission of information, we should consider the effective way of identifying root cause of such errors. By doing this, we can easily eliminate the root cause of errors. Therefore, it is more important to find out the effective way of identifying the root cause of errors than finding out the way of overcoming errors during transmission. If we find out the root cause of such errors, then, we can determine which way is more effective between elimination of the root cause and minimization of errors with consideration of the root cause. To find out the way of identifying the root cause of errors caused by media like air, three kinds of information are required. This information should be original source information before transmission, received-recovered information, and information during transmission. If we can compare the three type information, we can easily identify in which stage errors are introduced.

But up to now, it has not been invented an effective way of acquiring and storing the wanted spectrums (or information) during transmission.

It is very easy to secure the original source information before transmission. It is also easy to secure the received-recovered information. But in case of information during transmission, it is not easy to secure such information. During the transmission of information, the information is generally up-converted. Therefore, the information has relatively high frequency spectrum. To save or store such high frequency spectrum, great amount of memory and computation power of processor are required. Further, a circuit of very high speed is required for such process.

So far, related art methods for identifying the root cause of errors have been mostly methods for comparing the original source information with the received-recovered information and estimating what has happened during the transmission.

Here, if an RF state of the time when the signals have been received, namely, a state of information conveyed in a transmission medium which is an intermediate stage can be stored and reproduced repeatedly, it is possible to trace errors due to the transmission medium and to prepare a measure thereto, and to perform design change of a circuit and a software in a more reasonable and faster manner.

Communication equipments currently under development are complicated more and more in their function and have multi-functions so that built-in software realization is complicated. Accordingly, errors of considerably complicated types would occur during development of the communication equipments. In that case, it is difficult to analyze a root cause using only information regarding the two stages consisting of the original source information at the transmitter and the received-recovered information at the receiver which have been used for the related art analysis.

That is, using only the original source information and the received-recovered information, it is not easy to discriminate whether the occurred errors are transient errors caused by the transmission medium's characteristics, or errors generated because the built-in software was not able to process a peculiar case, or errors generated because the hardware and the software generated errors simultaneously. In that case, trouble-shooting can not be properly performed with the error left unsolved.

### SUMMARY OF THE INVENTION

Accordingly, the present invention is directed to an apparatus and a method for storing/recovering spectrum that substantially obviate one or more problems due to limitations and disadvantages of the related art.

An object of the present invention is to provide an apparatus and a method for storing/recovering spectrum, wherein wired/wireless band signal spectrum of a predetermined period of time before and after a moment an event is generated when the event such as loss, transformation, and noise addition is generated to source information (e.g., voice, image information) to be transmitted due to transmission medium's characteristics, is stored in form of data, an event generation state is repeatedly reproduced as many time as necessary so that a state of the spectrum of before and after the moment the event has been generated in the wired/wireless band may be analyzed, and data for use in analyzing a cause of errors due to the transmission medium's characteristics (e.g., air, copper wire) or for use in redesigning an equipment is provided.

Another object of the present invention is to provide an apparatus and a method for storing/recovering spectrum, wherein wired/wireless RF band signals are down-converted to a predetermined band using a wired/wireless receiver circuit appropriate for the band so that wired/wireless band spectrum may be stored in form of data, then the down-converted predetermined band signals are converted into data and stored, so that a cause of errors due to a transmission medium can be analyzed fast and exactly.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for storing/recovering spectrum, which includes: a radio-frequency (RF) receiver block for receiving spectrum of signals (predetermined RF band signals) transmitted through a predetermined RF band, down-converting the spectrum to a predetermined band lower than the predetermined RF band, and converting the down-converted spectrum of the predetermined band signals into digital data; a plurality of memory blocks for storing the converted digital data; an RF transmission block for receiving the stored digital data to recover the initially received predetermined RF band signals; a control circuit for converting information within the spectrum of the signals down-converted to the predetermined band lower than the predetermined RF band into a frame using the digital data received from the RF receiver block to store the frame in the memory blocks, and controlling the RF transmission block to recover the initially received predetermined RF band signals to original signals.

In another aspect of the present invention, there is provided a method for storing/recovering spectrum, which includes the steps of: receiving spectrum of signals (predetermined RF band signals) transmitted through a predetermined RF band, down-converting the spectrum to a predetermined band lower than the predetermined RF band, and converting the down-converted spectrum of the predetermined band signals into digital data; temporarily storing the converted digital data; inserting predetermined data portion satisfying predetermined requirements among the temporarily stored digital data into a data frame and storing the data frame; separately storing information stored in the data frame in a predetermined storage medium; receiving the information stored in the data frame to recover the initially received predetermined RF band signals; and re-transmitting the recovered initially received predetermined RF band signals to an external device that has received the same signals as the received predetermined RF band signals.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an apparatus for storing/recovering spectrum according to an embodiment of the present invention;

FIG. 2 is a diagram of a structure of a fast and medium capacity memory block according to an embodiment of the present invention;

FIG. 3 is a view illustrating a structure of a data frame stored in a large capacity memory block according to the present invention;

FIG. 4 is a block diagram illustrating a structure of an RF receiver circuit according to an embodiment of the present invention; and

FIG. 5 is a block diagram illustrating a structure of an RF transmitter circuit according to an embodiment of the present invention.

### DETAILED DESCRIPTION OF THE INVENTION

Reference will now be made in detail to the preferred embodiments of the present invention, examples of which are illustrated in the accompanying drawings.

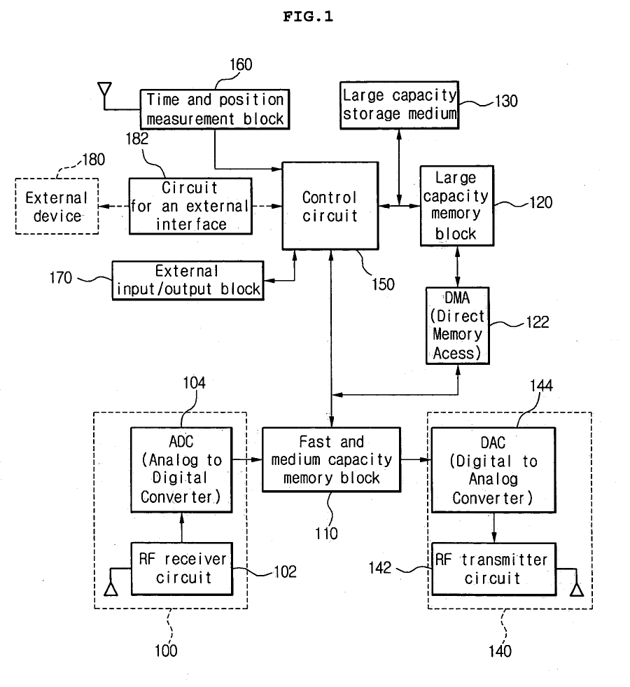

FIG. 1 is a block diagram of an apparatus for storing/recovering spectrum according to an embodiment of the present invention.

The apparatus for storing/recovering spectrum according to an embodiment of the present invention includes: a radio-frequency (RF) receiver block 100 for receiving spectrum of signals (predetermined RF band signals) transmitted through a predetermined RF band, down-converting the spectrum to a predetermined band, i.e., a post-baseband lower than the RF band, and converting the down-converted spectrum of the predetermined band signals into digital data; a plurality of memory blocks 110, 120, and 130 for storing the converted digital data; an RF transmission block 140 for receiving the stored digital data to recover the initially received predetermined RF band signals; a control circuit 150 for converting all information within the spectrum of the signals that correspond to the predetermined RF band into a frame using the digital data received from the RF receiver block 100 to store the frame in the memory blocks 110, 120, and 130, and controlling the RF transmission block 140 to recover the initially received predetermined RF band signals to original signals.

Here, the RF receiver block 100 includes: an RF receiver 102 for receiving spectrum of analog signals transmitted through a predetermined RF band (e.g.: wired/wireless band of 900-905 MHz) to down-convert the spectrum to a predetermined band, i.e., a post-baseband (e.g.: 0-5 MHz) lower than the RF band; and an analog-to-digital converter (ADC) 104 for converting the spectrum of the down-converted predetermined band analog signals into digital data through sampling.

Further, the plurality of memory blocks include: a fast and medium capacity memory block 110 (e.g.: static random access memory (SRAM), dynamic random access memory (DRAM), flash memory) having cyclic-buffer-type memory bank in which digital data received from the ADC is temporarily stored; a large capacity memory block 120 (e.g.: hard disk drive (HDD)) in which predetermined data portion satisfying predetermined requirements among the digital data stored in the fast and medium capacity memory block 110 is converted into a data frame under control of the control circuit 150 and is transferred in high speed and stored by a direct memory access (DMA) device 122; and a large capacity storage medium 130 (e.g.: compact disk (CD)-read only memory (ROM), digital video disk (DVD)) for separately storing the data so that the data converted into the data frame format and stored in the large capacity memory block 120 may be conserved permanently.

Here, the predetermined data portion satisfying the predetermined requirements is data when the RF band signals being received is determined as being signals to be stored by user's judgment. That is, the predetermined data portion is the digital data formed by converting and storing the spectrum itself of the predetermined band signals for a predetermined period of time before and after a reception point of the signals to be stored. At this point, whether the RF signals being received are normal or not can be determined by user's judgment.

For example, the data may mean digital data formed by converting and storing the spectrum itself of the predetermined band signals for a predetermined period of time before and after an abnormal signal intervening point in case the abnormal signals judged by the user intervene in the RF band signals being received.

Further, the RF transmission block 140 includes: a digital-to-analog converter (DAC) 144 for receiving the information stored in form of the frame and converting the information into analog signals; and an RF transmitter circuit 142 for up-converting the converted post-baseband analog signals to the initially received RF band signals to recover the spectrum of the initial RF band signals and transmitting the recovered spectrum to the external device.

Further, the apparatus for storing/recovering spectrum according to an embodiment of the present invention further includes: a time/position measurement block 160 for measuring time and a position where the spectrum of the predetermined band signals, i.e., the post-baseband signals is converted into the digital data and stored; an external input/output block 170 (e.g.: display block, character input block, microphone and speaker) for inputting to the control circuit 150 a condition that determines whether to store spectrum of a predetermined moment in the large capacity memory block of the memory blocks among spectrum of the RF band signals being received; a circuit for an external interface 182 for connecting an external device 180 that receives the spectrum of the signals transmitted through the predetermined RF band with the control circuit 150.

Here, the external device 180 can be a terminal, a base station and, namely, is a device for receiving the same signal as the RF band signal to be received.

Operation of the present invention will be described.

As one of embodiments explaining operation of the present invention, description will be made for a case an event desired by a user is generated. The user may desire to store a normal reception state but mostly the user desires to store abnormal signals or a peculiar signal state. Though various cases are possible, assume that RF band signals being received are judged to be abnormal signals by the user and the user intends to store the signals, for example. In detail, in case abnormal signals of more than a predetermined level intervene in the RF band signals being received, assume that wireless band signals of 900-905 MHz for total ten minutes of from −5 minutes to +5 minutes after an abnormal signal intervening point are to be stored.

If a power is applied to the apparatus for storing/recovering the spectrum, the control circuit 150 receives first from the external input/output interface block 170 a judgment condition as to an event generation desired by the user, namely, a condition for judging whether additional signals are abnormal signals if the signals intervening in the RF band signals being received are added.

In more detail, the external input/output interface block 170 receives detailed information regarding a wireless band (e.g.: 900-905 MHz) the user desires to store and setting condition information regarding a point at which spectrum of the RF band signals inputted by the user should start to be stored, through a touch screen of the character input block (keypad, mouse) or the display block (liquid crystal display (LCD)).

For example, if the user selects a ‘storing start’ command using the character input block or the display block, information of RF spectrum before and after 5 minutes from this point can be stored. In another manner, the information of the RF spectrum can also be automatically stored when a predetermined state desired by the user is satisfied even without selection of the ‘storing start’ command.

Further, if the user speaks voice information desired by the user (e.g.: audio information such as test object, test summary, weather condition, tester's name spoken by the tester) through a microphone, the control circuit receives the voice information from the microphone, executes an audio compression program in order to convert the voice information into a form that can be conveniently stored, converting the voice information into an audio compressed file, and stores the file in the large capacity memory block 120 using a name designated by the user.

The stored audio file is used in cooperation with the data frame and moved, stored, or recovered together as an annexed file of the data frame when the data frame stored in the large capacity memory block is wanted to be moved, stored, or recovered in the large capacity storage medium.

If the user inputs a command to recover the stored predetermined RF spectrum converted into the digital data through an input/output block (for example, if the user presses ‘recovery start’ button), the control circuit 150 analyzes again the RF spectrum data frame to recover the RF spectrum, simultaneously finds out the voice file stored together with the data frame, outputs the voice file through the speaker so that the user may hear, and recovers the RF spectrum using the RF transmitter circuit 142 to provide the recovered RF spectrum to the external device through an antenna or a coaxial cable.

The control circuit 150 reads information related to all events inputted from the user using the external input/output interface block 170, stores the information in a predetermined memory, and analyzes the stored information.

The control circuit 150 analyzes wireless band information selected by the user to supply frequency-synthesizer related data to an RF receiver circuit 102 and an RF transmitter circuit 142 so that synthesizers of the RF receiver circuit 102 and the RF transmitter circuit 142 may generate appropriate frequencies, and controls and records an amplifier gain within the circuit so that the RF receiver circuit 102 and the RF transmitter circuit 142 may receive and transmit signals of 900-905 MHz.

After that, the control circuit 150 keeps converting predetermined RF spectrum of 900-905 MHz into post-baseband signals, sampling the converted post-baseband signals to convert the sampled signals into data, and circulating and storing the data in a fast and medium capacity memory block 110 until the user inputs the ‘storing start’ command or the predetermined state inputted by the user is satisfied, regardless of whether an event inputted through the RF receiver circuit 102 by the user being generated or not.

In more detail, the control circuit 150 down-converts the RF signals of 900-905 MHz currently being received into post-baseband signals of 0-5 MHz using the RF receiver circuit 102. The down-converted post-baseband signals of 0-5 MHz are sampled and converted into digital data by the ADC 104. The converted digital data is sequentially stored first in the fast and medium capacity memory block 110 (e.g.: SRAM, DRAM, flash memory) operating in a cyclic-buffer memory bank type.

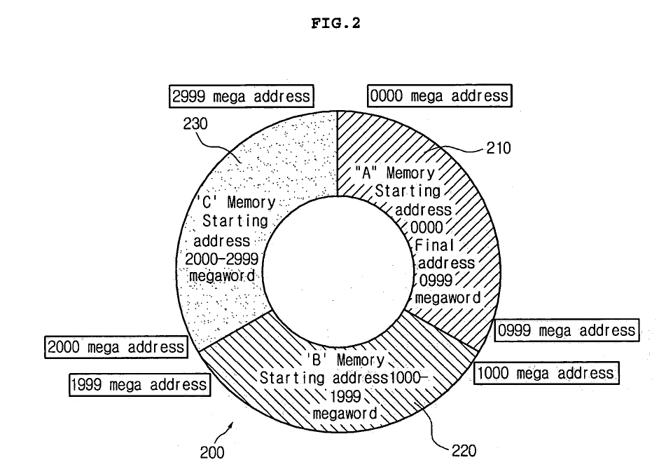

FIG. 2 is a diagram of a structure of a fast and medium capacity memory block according to an embodiment of the present invention.

To explain operation of a cyclic-buffer type memory bank 200 of the fast and medium capacity memory block, it is assumed that the fast and medium capacity memory block consists of total 3 giga word and the memory block has a memory bank structure such that three memories of 1 giga-word unit are connected each other in a circular shape (cyclic buffer type).

Referring to FIG. 2, with an assumption that the respective 1-giga-memory words are A, B, and C memories 210, 220, and 230, if the A memory 210 is all filled with data analog-digital converted from the post-baseband signals outputted from the RF receiver circuit 102, next inputted analog-digital converted data starts to be stored in the first address of the B memory 220.

If the B memory 220 is completely filled in this manner, the first address of the C memory 230 is filled this time. If all of addresses in the C memory 230 are filled with the analog-digital converted data from the RF receiver circuit 102, next inputted data is overwritten again on the first address of the A memory 210 and recorded and stored thereon. The bank structure of connecting and operating the three memories in a circular shape as described above is called a cyclic-buffer type memory bank.

As described above, the spectrum of the signals transmitted through the predetermined RF band, i.e., the RF band (e.g.: 900-905 MHz) desired by the user is received, the received spectrum is down-converted to the post-baseband, the down-converted post-baseband is converted into the digital data by the ADC, and the converted digital data is stored in the fast and medium capacity memory block 110. Under this state, if an event is generated at a predetermined moment, e.g., if abnormal signals of more than a predetermined level intervene in the RF band signals being received, all of data stored in the fast and medium capacity memory block 110 for a predetermined period of time (e.g.: from −5 minutes to +5 minutes) before and after a predetermined moment are moved to the large capacity memory block 120 (e.g.: hard disk drive) through the DMA device 122 in high speed.

Whether the signals are an event is judged by the user, thus even in case normal signals are received the normal signal can be stored in the large capacity memory block 120.

Further, the data stored in the large capacity memory block 120 is divided in a predetermined appropriate size, converted into a predetermined data frame format, and moved to the large capacity storage medium 130 such as CD-ROM, DVD and recorded and stored thereon so that the data may be stored and conserved in a maintenance-convenient manner.

In more detail, assume that the digital data analog-digital converted from the predetermined band analog signals being inputted from the RF receiver circuit 102 are being sequentially stored in the fast and medium capacity memory blocks A, B, and C 210, 220, and 230, and 250-mega words are required for storing the data for one minute. With this assumption, if seven minutes elapse since the apparatus of the present invention starts to operate, that is, e.g., if an event desired by the user is generated at a moment when the analog-digital converted data is recorded at an address of 750-mega word of the B memory 220, the control circuit recognizes and analyzes the state to regard the address of 750 mega word of the B memory 220 as an address of 0-time which is an event start address and store the address. The control circuit finds out storage addresses at which the analog-digital converted data recorded 5 minutes before (e.g., address of 500 mega word of A memory) and after (e.g., address of 1 giga word of C memory) the stored address are stored using a computation algorithm and recognizes these addresses as storage addresses of sampled data before and after 5 minutes from the stored address and stores the same.

If all analog-digital converted data constantly being inputted from the RF receiver circuit since the 0-time are stored in the fast and medium capacity memory block 110 and the data is all stored even in the calculated storage address of +5 minutes of the fast and medium capacity memory block 110, the inputted analog-digital converted data inputted are not stored in the fast and medium capacity memory block 110 any more and the analog-digital converted data at all of the addresses that correspond to a time portion of from −5 minutes to +5 minutes start to be moved to and stored in the large capacity memory block 120.

That is, all of the analog-digital converted data in the address portion of from −5 minute storage address (500 mega word of A memory) to +5 minute storage address (1 giga word of C memory) start to be moved and stored in the large capacity memory block 120 using the DMA device 122 under control of the control circuit 150.

Further, the analog-digital converted data moved to the large capacity memory block 120 are combined with other data to constitute a predetermined data frame.

That is, the analog-digital converted data constitutes one data frame together with position and time data, a variety of parameter values of the RF receiver circuit, state (or control) information of an external device.

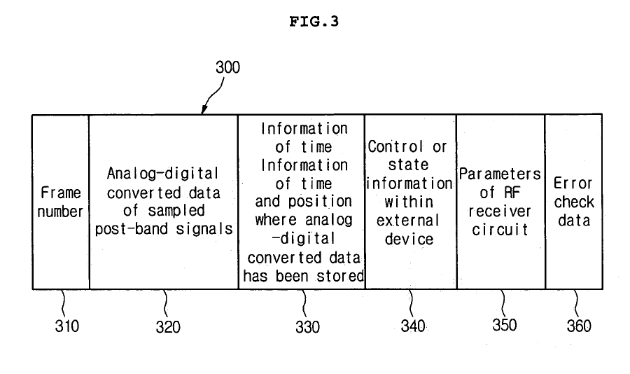

FIG. 3 is a view illustrating a structure of a data frame stored in a large capacity memory block according to the present invention.

The structure of the data frame stored in the large capacity memory block 120 can be changed depending on communication systems used but a form obtained by making application of a basic structure illustrated in FIG. 3 is generally used.

Further, the control circuit completes the data frame within the large capacity memory block 120, converts the data frame into a file, and moves the file to the large capacity storage medium such as DVD and stores the moved file together with a user's voice file related to the event inputted by the user.

Referring to FIG. 3, the data frame 300 includes: a frame number 310; analog-digital converted data 320 of sampled post-baseband signals; time and position information 330 of a point at which the analog-digital converted data has been stored; state (or control) information 340 within an external device (i.e.: terminal, base station) connected with the apparatus for storing/recovering the spectrum; parameters 350 for the RF receiver circuit (e.g.: intermediate frequency (IF) automatic gain control (AGC) amplifier's gain synchronized with a sampling clock in case of an IF-type receiver circuit, a baseband amplifier's gain synchronized with a sampling clock in case of a direct-conversion-type receiver circuit, frequency synthesizer information); and error check data (e.g.: cyclic redundancy check (CRC) data) 360.

The analog-digital converted digital data 320 of the post-baseband signals sampled and stored for a predetermined period of time due to generation of the predetermined event is generated in large amount in high speed among the above-mentioned values, but the time and position information 330, the parameters 350 for the RF receiver circuit, the control (or state) information 340 within the external device are not information that should be generated and stored in high speed. Thus, to store the information having different characteristics in one frame, the control circuit 150 discriminates and combines the information moved from the large capacity memory block 120 and stored in the fast and medium capacity memory block 110 and various information (position, time, state (or control) information within the external device) read by the control circuit to convert the combined information into a data frame, and stores the data converted into the data frame in the large capacity storage medium 130 for permanent conservation or database establishment purpose.

That is, depending on the data characteristics, the time and position information 330, the parameters 350 for the RF receiver circuit, the state (or control) information 340 within the external device need not to be stored as the same way as is the post-baseband data 320 stored after the data 320 is sampled millions of times per second and analog-digital converted. Thus, it is sufficient that other data except the post-baseband data 320 is recorded thousands of times per second depending on application fields of the present invention.

Therefore, about thousands of analog-digital converted post-baseband data 320 can constitute one data frame together with one time and position information 330, parameters 350 for the RF receiver circuit, state (or control) information 340 within the external device depending on the application fields.

The data converted into the frame under control of the control circuit 150 can be moved to the large capacity storage medium 130 such as CD-ROM and DVD and recorded and stored thereon and further converted into storage/maintenance-convenient form if the user desires.

Further, the control circuit 150 can display whether operation performance of the present invention is successful or not using the display block, request the user to input a file name for use in storing the file, and attach the file name to the file to store the file in the large capacity memory block 120 if the user inputs the file name.

Further, if a predetermined file is requested to be moved to the large capacity storage medium 130 and stored thereon, the control circuit 150 can move the file stored in the large capacity memory block 120 to the large capacity storage medium 130 and store the same again together with the file name.

If a command to recover the RF spectrum stored in an inside of the data frame, i.e., the analog-digital converted digital data 320 of the post-baseband signals sampled and stored for a predetermined period of time due to a predetermined even generation is made, the control circuit 150 reads and analyzes the command and accesses the large capacity storage medium in which the RF spectrum to be recovered is stored.

All of the data frame stored in the large capacity storage medium 130 are moved to the large capacity memory block 120 and stored thereon so that all of the data may be recovered back to the original RF band spectrum. The data in the frame are analyzed and classified again in the large capacity memory block 120 and the related data are redistributed and sent to the RF transmitter circuit 142, the DAC 144, and the external device 180.

Reclassification and redistribution of the data in the data frame related to the RF transmitter circuit 142 and the external device 180 will be described below.

Under control of the control circuit 150, the post-baseband related data to be transmitted to the RF transmitter circuit 142, namely, the analog-digital converted digital data 320 of the post-baseband signals sampled and stored for a predetermined period of time due to generation of the predetermined event is extracted from the data frame in the large capacity memory block 120 and sequentially sent to the fast and medium capacity memory block 110. The data sent to the fast and medium capacity memory block is sent to the DAC 144 of the RF transmission block 140 after a predetermined time delay and pass through the RF transmitter circuit 142, where the data is finally recovered to the original RF spectrum.

Further, the parameters 350 of the RF receiver circuit are extracted from the data frame within the large capacity memory block 120 under control of the control circuit 150. Before the extracted parameters are sent to the RF transmitter circuit 142, the control circuit 150 analyzes and processes the extracted parameters.

That is, inverse numbers of the RF parameters related to an AGC of the RF receiver circuit 102 are calculated and sent to a variable gain transmitter amplifier of the RF transmitter circuit 142, and frequency related information is sent to the frequency synthesizer of the RF transmitter circuit 142, so that desired RF spectrum can be recovered.

Further, the state (or control) information 340 inputted from the external device 180 (e.g.: terminal, base station), are transmitted again to the external device 180 through the circuit for the external interface 182. The external device 180 can reproduce an internal state (or control) synchronized with the RF spectrum recovered by the post-baseband signals using the above information within the external device 180.

Further, the control circuit 150 controls time and position information 330 to be displayed in form of a separate locus or point on a map of the relevant region through the display block (e.g.: LCD) of the external input/output interface block 170 in cooperation with the built-in map of the relevant region so that the user can easily recognize the information.

Further, the control circuit 150 separates, from the data frame moved to the large capacity memory block 130 and stored thereon, the post-baseband signal data, i.e., only the analog-digital converted digital data 320 of the post-baseband signals sampled and stored for a predetermined period of time due to generation of the predetermined event from other data to sequentially move again all of the separated data to the fast and medium capacity memory block 110. The fast and medium capacity memory block 110 operates as described below.

If the fast and medium capacity memory block 110 is the cyclic-memory bank type as described above, the data is moved to the A memory 210 through the DMA 122 first and stored thereon. If the data is all moved to the A memory 210 and stored thereon completely, the DMA 122 moves residual data to the B memory 220 and stores the data thereon.

If the data is completely stored in the B memory 220, the same operation is repeatedly performed for the C memory 230. While the data is moved to the C memory 230 and stored thereon, the data already stored in the A memory 230 is inputted to the RF transmitter circuit 142 through the DAC 144, where the data is recovered to desired RF band signals.

Generally, since operation speed of the fast and the medium capacity memory block 110 is faster than that of the large capacity memory block 120, the spectrum is recovered after operation for moving the data to the A, B, and C memories 210, 220, and 230 is completed first.

By doing so, over-run or under-run phenomenon which might be generated in a buffer can be prevented. Though the data on the A memory 210 are all digital-analog converted and so the data are recovered to analog signals, moving and storing of the data is already completed in the B and C memories 220 and 230, thus the over-run or under-run phenomenon is not generated. If the data on the A memory 210 are all digital-analog converted, the control circuit moves the next data and stores the same by overwriting the data. That is, circulation storage is possible.

Since the fast and medium capacity memory block 110 is used in a circulation manner, the original RF band signals can be continuously recovered to the original RF spectrum.

The data moved to the fast and medium capacity memory block 110 are used in generating the analog post-baseband signals through the DAC 144 under control of the control circuit 150. Further, the signals are inputted to the RF transmitter circuit 142 and up-converted up to a desired RF band.

At this point, if the RF transmitter circuit 142 is of a direct-conversion type, the frequency synthesizer generates a local frequency using data regarding frequency information received from the control circuit 150 to directly up-convert the post-baseband signals to the desired RF band.

If the RF transmitter circuit 142 operates in an IF type, the control circuit 150 sends information regarding IF local frequency synthesis and information regarding RF local frequency synthesis to the frequency synthesizer. At this point, the frequency synthesizer generates a required frequency so that the post-baseband signals are up-converted to an IF band signals first and then the IF band signals are up-converted to the desired RF band signals.

The RF transmitter circuit and the RF receiver circuit, which are elements of the present invention, can be realized in both two types, i.e., a super-heterodyne type that uses an IF frequency and a direct-conversion type that does not use the IF frequency.

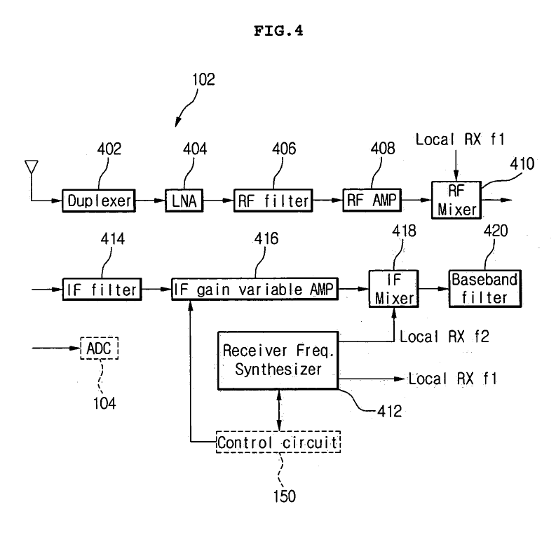

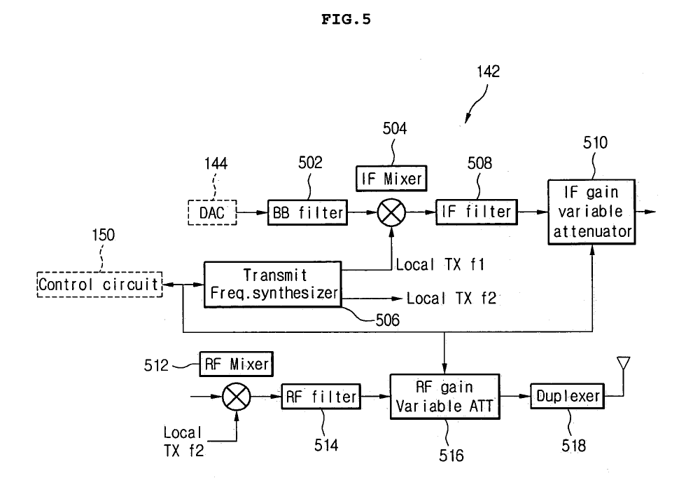

Structure and operation of the RF transmitter circuit and the RF receiver circuit, which are elements of the present invention, will be described with reference to FIGS. 4 and 5.

FIG. 4 is a block diagram illustrating a structure of an RF receiver circuit according to an embodiment of the present invention, and FIG. 5 is a block diagram illustrating a structure of an RF transmitter circuit according to an embodiment of the present invention.

Since the RF receiver and transmitter circuits described with reference to FIGS. 4 and 5 are mere one embodiment that operates in the super-heterodyne type, they are not necessary limited to this type.

Referring to FIG. 4, the RF receiver circuit 102 down-converts a predetermined RF band selected among the spectrum of the signals transmitted through the RF band inputted from the antenna into the post-baseband under the control of the control circuit 150.

The predetermined RF band signals received from the antenna are divided into transmission and reception signals by a duplexer 402 and the divided reception signals go through a low noise amplifier (LNA) 404 of high gain, where the reception signals are amplified first.

An RF filter 406 filters the amplified RF reception signals to minimize unnecessary signals except the selected band and an RF amplifier 408 amplifies the filtered signals enough to be supplied as an input of an RF mixer 410. The amplified signals are provided to one input of the RF mixer 410.

Further, a receiver frequency synthesizer 412 receives information necessary for frequency synthesis from the control circuit 150 to generate a local RX f1 and a local RX f2.

Further, the RF mixer 410 multiplies the amplified RF reception signals by the local RX f1 signal generated by the receiver frequency synthesizer 412 to generate IF signals.

A IF filter 414 minimizes the unnecessary signals except the IF band among the IF signals and the filtered signals are inputted to an IF gain variable amplifier 416.

The IF gain variable amplifier 416 whose gain can be adjusted by the control circuit 150 amplifies the IF signals as much as a data commanded by the control circuit 150.

The IF signals whose amplitudes have been appropriately amplified are provided to one input of an IF mixer 418 so as to be down-converted to a baseband. The IF mixer 418 mixes the local RX f2 frequency generated by the receiver frequency synthesizer 412 with the amplified IF signals to generate the post-baseband signals and twice IF band signals.

A baseband filter 420 filters only the post-baseband signals to minimize the unnecessary signals except the post-baseband signals and provides the filtered signals to the ADC 104, where the post-baseband signals are converted into data.

Further, the control circuit 150 computes an average energy of these post-baseband signals using the analog-digital converted data of all of the post-baseband signals within an interval of a predetermined period.

If the average energy of the post-baseband signals computed in the interval of the predetermined period as described above is smaller than a value set in advance, the control circuit sends control data to the IF gain variable amplifier 416 so that the gain of the IF gain variable amplifier 416 may be increased. The IF gain variable amplifier 416 increases gain according to this control data and amplifies the IF signals.

On the contrary, if the average energy of the post-baseband signals computed in the interval of the predetermined period is greater than the value set in advance, the control circuit sends corresponding control data to the IF gain variable amplifier 416. In that case, the IF gain variable amplifier 416 decreases the gain according to the control data and amplifies the IF signals.

That is, the processes of computing the average energy of the post-baseband signals in the interval of the predetermined period to check whether the amplitude of the current IF reception signals has a value within an appropriate input range of the ADC 104 and adjusting the gain of the IF gain variable amplifier 416 in the interval of the predetermined period to amplifying the signals in a variable manner, are repeated thousands of times per second.

At this point, the control circuit 150 synchronizes the gain-related control data which has been provided to the IF gain variable amplifier 416 together with the frequency synthesis information which has been provided to the receiver frequency synthesizer 412, with the post-baseband signal data which have been used in computing the average energy to store the same together with the data frame illustrated in FIG. 3.

Next, a signal processing procedure of the RF transmitter circuit will be described with reference to FIG. 5.

The RF transmitter circuit 142 up-converts the post-baseband signals generated through the DAC 144 to the selected RF signal band under control of the control circuit 150.

A baseband filter 502 minimizes unnecessary signals except the post-baseband signals generated through the DAC 144 and provides the filtered signals to one input of an IF mixer 504.

A transmit frequency synthesizer 506 generates two frequencies of a local TX f1 and a local TX f2 using frequency-synthesis related data received from the control circuit 150, and an IF mixer 504 mixes the local TX f1 and an output of the baseband filter 502 to up-convert the post-baseband signals to the IF band.

An IF filter minimizes unnecessary signals except the generated IF band signals and provides the filtered signals to an IF gain variable attenuator (IFGVA) 510. The IFGVA 510 receives control data related to attenuation degree every predetermined period from the control circuit 150 to determine an attenuation degree and attenuates the inputted signals.

The signals attenuated in this manner are inputted to an RF mixer 512 together with the local TX f2 signal. The RF mixer 512 up-converts the IF signals to a selected RF band.

Further, an RF filter 514 filters the up-converted signals to minimize unnecessary signals except the selected RF band signals. The filtered signals are inputted to an RF gain variable attenuator (RFGVA) 516 whose attenuation degree is determined by the control circuit 150. An output of the RFGVA 516 pass through a duplexer 518 and is provided to the external device (refer to the reference numeral 180 of FIG. 1) connected with the apparatus of the present invention through an antenna, a coaxial cable, or an RF coupler.

The attenuation degree of the IFGVA 510 or the RFGVA 516 of the RF transmitter circuit 142 is determined in the following way by the control circuit and provided to the IFGVA 510 and the RFGVA 516.

That is, the control circuit 150 computes an inverse value of the gain of the IF gain variable amplifier that has been used for the RF receiver circuit 102 and provides the inverse value to the IFVGA 510 or the RFVGA 516 of the RF transmitter circuit 142 every period set in advance to control an RF output power.

If a dynamic range of the IFVGA 510 is not sufficient, it is possible to generate an RF transmission output having the same power level as the RF band reception signals by providing additional attenuation-degree information to the final RFVGA 516.

The recovered RF signals can be provided to the external device (refer to the reference numeral 180 of FIG. 1) (terminal or base station) through a coaxial cable or induction coupling circuit (e.g.: RF coupler). At this point, it is possible to control the external device to operate in complete synchronization with the recovered RF signals by sending again the internal state (or control) information related to the external device 180 that has been stored in the same data frame in synchronization with the post-baseband signals currently being played, to an external terminal or an inside of the system, i.e., the external device 180 through the circuit for the external interface 182 of FIG. 1 while supplying the recovered RF transmission signals.

With such configuration, the external device can connect the external device's internal state (or control) of the time when an event has occurred with the RF spectrum of the time when the event has occurred which the external device has received, and play the event occurring state as many time as necessary. While the state is played several times repeatedly, a cause analysis for the event occurrence and a measure thereto can be achieved.

As described above, in case a communication system generates a problem during its operation, namely, in case an event occurs, the apparatus and the method for storing/recovering the spectrum can compare the normal spectrum with the abnormal spectrum and analyze the results repeatedly by discriminating the RF state of the time of the event generation from the RF state of the normal operation, for example, discriminating the channel spectrum characteristics of the normal operation state from that of the abnormal operation state to exactly recover the spectrum characteristics, respectively.

Further, this application function can also be used in reexamining whether there has been a problem in the system of the time of the event generation and in reexamining expected causes. In case a predetermined software keeps generating an error under a predetermined RF state in a system where a complicated software is in operation, the apparatus play the state repeatedly as many time as necessary to realize the RF state of the time of the event generation, so that a defect in the software of the terminal or the communication system found during the software operation can be swiftly understood and modified.

In addition, if normal or abnormal RF state data gathered and recorded for the respective different time bands and time points are all stored and converted into a database, a predetermined RF state of a predetermined place of the time when the normal or the abnormal data has occurred can be realized in a laboratory even without visiting again the geographical point in case a similar terminal or a new terminal having an improved performance or system is developed. Therefore, a field test time and a time consumed in understanding a cause of an error can be remarkably reduced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for storing/recovering spectrum comprising:
an RF (radio-frequency) receiver block for receiving spectrum of signals (predetermined RF band signals) transmitted through a predetermined RF band, down-converting the spectrum to a predetermined band lower than the predetermined RF band, and converting the down-converted spectrum of the predetermined band signals into digital data;
a plurality of memory blocks for storing the converted digital data;
an RF transmission block for receiving the stored digital data to recover the initially received predetermined RF band signals; and
a control circuit for converting information within the spectrum of the signals down-converted to the predetermined band lower than the predetermined RF band into a frame using the digital data received from the RF receiver block to store the frame in the memory blocks, and controlling the RF transmission block to recover the initially received predetermined RF band signals to original signals.

2. The apparatus of claim 1, wherein the plurality of memory blocks comprise:
a fast and medium capacity memory block for temporarily storing the digital data received from the RF receiver block;
a large capacity memory block in which predetermined data portion satisfying predetermined requirements among the digital data stored in the fast and medium capacity memory block is converted into a data frame by the control circuit and stored; and
a large capacity storage medium for separately storing the data so that the data stored in the large capacity memory block is conserved permanently.

3. The apparatus of claim 1, further comprising:
a time/position measurement block for measuring time and a position where the spectrum of the down-converted predetermined band signals are converted into the digital data and stored;
an external input/output block for inputting to the control circuit a condition that determines whether to store which spectrum among spectrums of the predetermined RF band signals being received in the large capacity memory block of the memory blocks; and
a circuit for an external interface for connecting an external device that simultaneously and separately receives the spectrum of the predetermined RF band signals with the control circuit.

4. The apparatus of claim 3, wherein the external device is a device for receiving the same signals as the predetermined RF band signals being received.

5. The apparatus of claim 2, wherein the predetermined data portion satisfying the predetermined requirements is digital data formed by converting and storing the spectrum itself of the down-converted predetermined band signals for a predetermined period of time including before and after an abnormal signal reception point if the predetermined RF band signals being received are judged to be the abnormal signals.

6. The apparatus of claim 2, wherein the data frame stored in the large capacity memory block comprises: a frame number, information regarding time and a position in which the data has been converted and stored, state (or control) information within an external device connected with the control circuit, and parameters and frequency information of a circuit for receiving the predetermined RF band signals besides the predetermined data portion satisfying the predetermined requirements.

7. The apparatus of claim 3, wherein the control circuit is connected with the external device so as to receive and store state (or control) information within the external device, and when recovering the initially received predetermined RF band signals and transmitting the recovered signals using the RF transmission block, the control circuit re-transmits the state (or control) information within the external device related to the recovered signals to the external device.

8. The apparatus of claim 3, wherein the control circuit is connected with the time/position measurement block so as to receive and store information regarding the time and the position in which the data has been converted and stored, and when recovering the initially received predetermined RF band signals and transmitting the recovered signals using the RF transmission block, the control circuit re-transmits the information regarding the time and the position to the external device.

9. A method for storing/recovering spectrum comprising the steps of:
receiving spectrum of signals (predetermined RF (radio frequency) band signals) transmitted through a predetermined RF band, down-converting the spectrum to a predetermined band lower than the predetermined RF band, and converting the down-converted spectrum of the predetermined band signals into digital data;
temporarily storing the converted digital data;
inserting predetermined data portion satisfying predetermined requirements among the temporarily stored digital data into a data frame and storing the data frame;
separately storing information stored in the data frame in a predetermined storage medium;
receiving the information stored in the data frame to recover the initially received predetermined RF band signals; and
re-transmitting the recovered initially received predetermined RF band signals to an external device that has received the same signals as the received predetermined RF band signals.

10. The method of claim 9, wherein the predetermined data portion satisfying the predetermined requirements is data formed by converting spectrum itself of the down-converted predetermined band signals for a predetermined period including before and after an abnormal signal reception point in case the predetermined RF band signals being received are judged to be abnormal signals.

11. The method of claim 9, further comprising the steps of:
judging whether to insert which spectrum among spectrums of the predetermined RF band signals being received into the data frame and store the same; and
measuring time and a position in which the spectrum of the down-converted predetermined band signals is converted into the digital data has been converted and stored.

12. The method of claim 9, wherein the data frame comprises: a frame number, information regarding time and a position in which the data has been converted and stored, state (or control) information within the external device, parameters and frequency information of a circuit for receiving the predetermined RF band signals besides the predetermined data portion satisfying the predetermined requirements.

13. The method of claim 9, further comprising the steps of:
receiving and storing state (or control) information within the external device; and
when recovering the initially received predetermined RF band signals and transmitting the recovered signals to the external device, re-transmitting the stored state (or control) information of the external device to the external device.

14. The method of claim 9, further comprising the steps of:
receiving and storing information regarding time and a position where the predetermined data portion satisfying the predetermined requirements is stored; and
when recovering the initially received predetermined RF band signals and transmitting the recovered signals to the external device, re-transmitting the stored information regarding the time and the position to the external device.
